(19) United States
(12) Patent Application Publication
(10) Pub. No.: US 2004/0170945 A1
(43) Pub. Date: Sep. 2, 2004

(54) General field isolation rubber dams without operative inserts which isolate the dental alveolar arch for dental treatment

(76) Inventor: John Heasley, Iowa City, IA (US)

Correspondence Address: DAVIS, BROWN, KOEHN, SHORS & ROBERTS, P.C., THE FINANCIAL CENTER, 666 WALNUT STREET, SUITE 2500, DES MOINES, IA, 50309-3993, US

(21) Appl. No.: 10/375,372

(22) Filed: Feb. 27, 2003

(51) Int. Cl. A61C 5/14

(52) U.S. Cl. 433/136

(57) ABSTRACT

A general field isolation rubber dam with particular applicability in the field of dentistry which is preferably composed of an elastic membrane with a slit-like central opening prepared in the dam through which a grouping of teeth and their associated soft tissues are brought into the dental operating field in order to perform dental treatment. The dams of this disclosure lack an integral retractive element, but rely instead on externally applied clamps and devices to retain and retract the membrane around an operative site. These dams may either have a mechanism for the bonding of manually applied barrier adhesives to perfect the moisture seal around an operative site or alternatively may have integrally applied barrier adhesives applied to directly adhere the rubber dam membrane to the oral tissues.

### BACKGROUND OF THE INVENTION

1. Field of the Invention

The invention relates generally to rubber dams and more particularly to general field isolation rubber dams used for the purpose of isolating the dental alveolar arch by retracting the cheeks, lips, and tongue, controlling moisture, and maintain a dry field during dental treatment. More specifically, this invention describes a classification of general field isolation rubber dams without integrally attached operative inserts which rely on externally applied clamps and retraction devices for retention and retraction and the utilize the application of unpolymerized barrier materials to complete a moisture seal around an operative work site.

2. Background

Dr. Sanford C. Barnum, of New York, invented the original rubber dam in 1864. It was instantly recognized and accepted as the first effective isolation modality that fulfilled the dentists' need to work in a dry operating field. The use of the rubber dam in dentistry has been continuous since that time, and its use has become accepted as the ‘gold standard’ of isolation of the oral cavity for dental treatment purposes throughout the world dental community. The techniques of dental rubber dam application are taught universally in dental schools both in the United States and abroad as the highest modality of operational site isolation in dentistry. Although the use of the rubber dam in dentistry is highly efficacious, some limitations in the design of the rubber dam membrane, and difficulties in the practical application of the rubber dam in clinical practice, limit the range of dental procedures, which may be accomplished with its use, and have caused an attrition rate in clinical practice, which is considerable. It is estimated that although all dentists are trained in the use of the rubber dam in dental school, in private practice only about 10% of practicing dentists regularly use the device. The principal reasons cited for this high attrition rate are difficulty of application and discomfort to the patient “Probably no other technique, instrument, or treatment in dentistry has been more universally accepted and advocated, and yet is so universally ignored by practicing dentists.” There seems to be an inverse relationship between the degree of regularity of use of this isolation device and the degree of difficulty experienced in applying it clinically. So many dentists abandon the technique in spite of the many of benefits bestowed upon the clinician who perseveres with the difficulties of its use. General field isolation as an alternative application modality of the rubber dam will have a contributory value in elevating the attainment of clinical excellence.

The conventional rubber dam application is cumbersome and impractical for application. In the conventional technique of rubber dam usage, the dental practitioner perforates the thin, flat sheet of rubber dam material with a series of holes corresponding to the number and configuration of teeth to be isolated within a proposed operative site. The perforated rubber dam is then inserted into the patient's mouth, and the perforations are stretched over individual teeth sequentially until the entire operating site is exposed. This technique exposes the clinical crowns of the teeth only (the visible portion of the teeth above the gum line), which restricts the dentist primarily to procedures associated with the hard structures of the teeth above the gum line. Because of this, prosthetic procedures in particular have been universally performed without the use of a rubber dam since they require instrumentation below the gum line for their completion. In order to prepare a tooth for a crown or an abutment for a bridge, exposure of both the visible portion of a tooth and some portion of the gingival soft tissues (the gums) is essential. Attempts have been made to isolate groups of teeth with the use of the conventional rubber dam by using the slit-dam technique of punching two or more holes in a conventional rubber dam with a rubber dam punch, and then cutting the interseptal rubber between the holes with a scissors to form a slit in the dam. With a modified rubber dam membrane, which isolates whole groups of teeth simultaneously instead of isolating individual teeth separately, as in the conventional rubber dam, a dentist may instrument teeth above and below the free marginal gingiva (the gum line). Currently, almost all prosthetic procedures are universally performed without the use of a rubber dam due to limitations inherent in the methods, techniques, and materials available in the conventional rubber dam usage.

The goal of isolating both the teeth and their associated soft tissues of the alveolar arch simultaneously to expose these structures effectively and at the same time create an effective operative perimeter with an impervious moisture seal has not yet been perfected in the prior art. All of the prior art devices fall short of this goal. The design of effective devices which act externally on a rubber dam membrane to control the perimeter of an operative site, have been largely ineffective in the prior art until the recent introduction of new cervical retraction rubber dam clamps and retaining devices by the author of this disclosure. New designs of externally applied rubber dam retraction devices to control a rubber dam membrane which lacks an internal integral mechanism has created a need for specially designed general field isolation rubber dams without operative inserts to complement the new retraction devices for maximum efficiency. Hence it is the purpose of this invention to disclose specially designed rubber dams which operate with maximum efficiency for the clinician while interacting with improved external retraction devices.

General field isolation rubber dams that do not have integral operative inserts for controlling the operative perimeter are useful isolation modalities for alveolar arch segments which are generally linear, such as the four posterior segments of the upper and lower arches, or alternatively are useful for isolating relatively short spans of curvature of the anterior segments. Field isolation of three to four teeth in the anterior segment is a typical application. In much longer curved segments of the alveolar arch, stretching of the rubber membrane in the lingual area creates an open gap where fluids may enter the operative site. In longer span isolation applications, general field isolation rubber dams with malleable operative inserts are indicated. Another inherent limitation of the general field isolation rubber dam without operative inserts is the tendency for the rubber dam membrane to snap back to the level of the gum line when the dam is retained with conventional rubber dam clamps. This limits clinical access primarily to the crowns of the teeth. If the clinician's desires isolation of only the clinical crowns of the teeth for simple restorative purposes, this application fulfills a valid clinical need, and allows a quick and efficient application of the dam. If the dentist requires both the teeth and associated soft tissues to be exposed for instrumentation, the newly designed cervical retraction rubber dam clamps mentioned earlier facilitates the retraction of the field isolation rubber dam for subgingival applications, which is a principal shortcoming of conventional rubber dam isolation. By making the rubber dam easier to use, extending the range of the rubber dam to prosthetic cases, and making the rubber dam more comfortable to the patient, field isolation rubber dams will encourage the majority of practicing dentists to begin to return to the use of the rubber dam as a valuable adjunct to dental clinical practice.

U.S. Pat. No. 5,078,604, which makes no pretensions about the device being a rubber dam, and instead describes it as a barrier drape, which it is because it lies passively over the intra-oral tissues in an attempt to avoid any stretching and the creation of internal stresses. This patent goes to great lengths to point out what are alleged to be the deficiencies of the rubber dam, foremost of which are the internal tensile stresses that an elastic membrane generates when stretched. The proposed solution is a concave ‘bag shaped’ barrier drape which is pre-contoured to all of the anatomical irregularities of the oral cavity; a drape which lies passively over all of the tissues of the oral cavity and generates no internal stresses by stretching. The patent ignores the fact that each and every patient has a different anatomic configuration, and that it is impossible to create a drape that satisfies every anatomy. It also ignores the fact that excess barrier material, if it protrudes too far back into a patient's mouth, will cause the patient to gag and choke, causing not only discomfort to the patient, but an interruption of the clinical treatment needs, let alone a wholesale failure of the device clinically. While a barrier drape may be fine if it is draped over a leg or other external body part, the same device applied intra-orally must contend with the patient's tongue, which moves and protrudes constantly, thus causing a loose barrier drape to flop all over the oral cavity and obstruct the dental surgeon's activities. This concept also ignores the fact that without the internal tension of a true rubber dam membrane, the lips and cheeks are not retracted; nor is the patient's mouth gently coaxed open to give access to the operative site for instrumentation. Instead, it proposes that auxiliary devices be applied to achieve these ends, rather than the action of the membrane.

The second device illustrative of the difference between a true rubber dam and an intra-oral barrier drape, is a German device which purports to be a rubber dam (cofferdam in the German language), but really is a barrier drape in disguise and is described in European Patent No. EP1006925AI (Horvath et al.). This is not a flat membrane, like a true rubber dam. Instead, it is described as “bag shaped . . . so that it fits easily into the oral cavity.” It is said to be “a rubber dam which is rolled up at its front end”, but by unrolling it, the bag shape of the dam can be protruded. Effectively, the concept is one of an oral prophylactic which comes from the factory rolled up like a condom, but after unrolling, a tubular or generally closed ended cylindrical membrane is exposed. The resultant membrane is then stuffed back into the oral cavity and throat of the patient in an attempt to provide a barrier. The problems with this concept are gagging and choking of the patient by excess membrane material, flopping around of the excess material by the actions of the patient's tongue, lack of retraction of the lips and cheeks, and a lack of the mouth being gently propped open by the membrane.

Various clamps and devices to retract the rubber dam from the work site have been introduced into the prior art. These retraction devices generally are used with the slit-dam technique of modifying the conventional rubber dam by cutting a slit in the dam with a scissors, then applying the clamp to the teeth to be isolated and stretching the rubber dam over the clamp or device to retract the rubber. Two devices which are rudimentary attempts at simple retraction of the rubber dam membrane in order to isolate a site are U.S. Pat. No. 5,503,556, and the Canadian product, Bond Buddy. Each of these devices are identical in the manner in which they retract a rubber dam membrane, so a comparison for one is applicable to the other. Each of the devices retracts in a manner in which the rubber dam is pulled laterally away from the tissues and subsequently each leave a gap which causes saliva and fluids to percolate through the membrane. Also, each of these devices is coplanar with their clamping action, which means that they retract the rubber dam membrane in a plane which is coincidental with gum line, preventing adequate subgingival access to prepare the margins of a crown or other prosthetic procedure. These devices are clamping devices only, not rubber dam membranes. Neither patent nor device describes any integral changes to a rubber dam membrane to facilitate general field isolation.

An intra-arch design of the Horvath patent describes an intra-arch rubber dam membrane which can be classified as a field isolation dam with two plastically deformable tape-like elements alternating with two elastic tape-like elements arranged around a slit-like opening in a square pattern. The design lacks the fundamental elements of an effective intra-arch general field isolation rubber dam with operative inserts, because the crude alternating plastic and elastic components don't function as an effectively linked three-dimensionally moldable operative perimeter. This disqualifies it as an effective general field isolation rubber dam with an integrally retractive operative insert mechanism, while also disqualifying it as a rubber dam without an operative insert, as in the classification of the field isolation dams of this disclosure.

U.S. Pat. No. 5,098,299 is a composition patent which specifies a formulation and makes mention to isolating tissue, but makes no mention of modifications of the rubber dam design or technique. Another formulation patent assigned to the same company, U.S. Pat. No. 6,086,370, describes a polymerizable isolation barrier which is applied with a syringe to form a coating of material in, around, or on teeth or gingival tissues to protect tissues from chemical irritation during treatment or to plug holes or gaps in leaky rubber dams. This patent is limited to the formulation described and claims to eliminate the need for the rubber dam altogether. It is supplied as a syringeable paste.

U.S. Pat. No. 5,803,734 describes a round button of thermoplastic material which is heated to a plastic state and linked to dental tissues or a rubber dam with an oral adhesive to either cushion a rubber dam clamp from damaging gingival tissues, or anchor a rubber dam to tissues, or to isolate tissues in a manner identical to the use of Orabase and rubber base adhesive with the conventional rubber dam and the slit-dam technique. A brief description of attachment of the thermoplastic material to a rubber dam to form a perimeter to a work site is mentioned, but no integral modification of the rubber dam membrane itself is described.

Dr. William H. Liebenberg, in the Compendium of Continuing Education in Dentistry, Vol. 19 (10):1028-1032, “Dental Dam Patch an Effective Intra-oral Repair Technique”, describes the use of cyanoacrylates in repairing the rubber dam and in bonding of the rubber dam to soft tissues with cyanoacrylates as a barrier material, but does not describe an integral design in the rubber dam at the time of its manufacture. Also, by the same author, The Rubber Dam Retaining Device: Adjunct to isolation during placement of multiple veneers, by William H. Liebenberg Quintessence International 1995; 26:493-500, describes an appliance prepared to the specifications of the author and fabricated in a dental lab to isolate an anterior segment of teeth for the preparation of laminate veneers. A rubber dam is cut, using the slit-dam method and glued to the appliance to create a field-assembled device to isolate teeth to prepare and seat porcelain veneer restorations.

In another article by William Liebenberg, Extending the Use of the Rubber Dam, Part 1; Quintessence International 1992:23:657-665, Liebenberg describes a practice of placing rubber dam retainers(clamps) in a forward and backward position to isolate an intermediate tooth for the purpose of preparing a cast post during prosthetic procedures. The rubber dam is stretched over the two clamps which shield the intermediate tooth for subgingival instrumentation.

U.S. Pat. No. 6,093,022 describes the use of an adhesive and elevated portions in a rubber dam to replace the rubber dam clamp when securing the rubber dam in the mouth. The rubber dam application described is a conventional approach where holes are punched and the dam slipped over individual teeth individually. There is no mention of any alternative application of the rubber dam. The only function of the improvement is to replace the traditional rubber dam clamp. The retention of the adhesive is to adhere to one tooth only, not to retain the whole dam. In addition, there is no use of the adhesive to act as a barrier material to seal the dam.

### SUMMARY OF THE INVENTION

The invention consists of a series of modified rubber dam membranes which allow unique alternative applications of the rubber dam to enable a dentist to isolate various portions of both the teeth and their surrounding soft tissues or gums simultaneously. While the conventional rubber dam technique relies on the perforation of individual holes in the rubber dam membrane to isolate the crowns of teeth individually, this series of devices generally isolate groups of teeth at a time, a technique called general field isolation in the prior art. While there have been attempts to isolate more than one tooth at a time by cutting a slit in a conventional rubber dam membrane with a scissors, a very limited and flawed technique called the slit-dam technique, to this date there have no systematic designs of alternative field isolation rubber dam membranes which address all of the problems of general field isolation in dentistry. (The exception to this statement is the author's other general field isolation disclosures pending the grant of patent, entitled Rubber Dams With Operative Inserts Which Isolate Anatomical Structures by Effectively Resisting External Vector Forces of Displacement—title amended from initial title of General Field Isolation Rubber Dams With Operative Inserts).

The series of rubber dam membrane devices consist generally of a flat, elastomeric membrane, with a slit-like central opening integrally prepared in the dam so that the dam may be stretched over a series of teeth simultaneously to isolate a segment of the alveolar arch in a process known in dentistry as general field isolation. The rubber dams described in this disclosure lack an integral device within the membrane which retracts the membrane when it is in position over an operative site. Instead, this series of dams relies on external devices such as clamps and retaining devices to accomplish retraction of the rubber dam membrane. The elastic field isolation membranes of this disclosure may be constructed with or without mechanisms for the attachment of barrier adhesives to refine the moisture seal around an operative site. In general, variations of general field isolation rubber dam membranes without operative inserts may either have mechanisms for the attachment of manually applied barrier substances or alternatively may have integrally applied barrier adhesives to perfect the seal of the dam around the operative site. Integrally applied adhesives may either be of the pressure sensitive or chemically activated or photo-polymerized composition.

The stretching of a rubber dam between the operative site and a framework which retains the outer perimeter of the dam induces tensile forces membrane during application which are transmitted to the operative site. Concurrently, opposing tensile forces are created by the stretching of the dam around the perimeter of the operative site. The result is that the rubber dam material around the operative site may be pulled away from its desired location, particularly when being used for field isolation. While these dams without operative inserts lack an integral mechanism for retraction of the membrane around the operative field, they rely instead on the application of externally applied clamps and retractive devices to achieve a comparable performance to the field isolation dams with operative inserts. This disclosure describes dams which attach to external frames which are separate devices, as well as dams with integral frames attached at the time of manufacture. In addition to describing the rubber dam membranes, this disclosure also briefly describes the ancillary field isolation clamps and devices which retract and retain these field isolation dams without integral operative inserts.

### BRIEF DESCRIPTION OF THE DRAWINGS

FIG. 1 is an isometric view of a posterior general field isolation rubber dam with a fabric mesh operative perimeter with an integral frame attached to the periphery of the membrane

FIG. 2 is an isometric view of an anterior general field isolation rubber dam with a fabric mesh operative perimeter without an integral frame attached.

FIG. 3 is a cross sectional view of a field isolation membrane with a slit central opening prepared and a mesh material attached around the periphery of the opening. The dam depicted also has an integral frame attached around the exterior of the membrane.

FIG. 4 is a cross sectional view of a field isolation membrane with a slit central opening and an adhesive attached to the operative side of the membrane around the periphery of the opening with a release liner applied over the adhesive. This dam has an integrally attached frame attached around the outside of the membrane.

FIG. 5 is a cross sectional view of a field isolation membrane with a slit central opening prepared and an adhesive applied to the tissue side of the membrane around the periphery of the opening with a release liner applied over the adhesive. This dam has an integrally attached frame around the outside of the membrane.

FIG. 6 is a cross sectional view of a field isolation rubber dam membrane with a slit central opening prepared and an adhesive applied to the operative side of the membrane around the opening. This dam has an integrally attached frame around the periphery of the membrane.

FIG. 7 is a cross sectional view of a field isolation rubber dam membrane with a slit central opening prepared and an integrally attached frame around the periphery of the membrane.

FIG. 8 is a cross sectional view of a field isolation rubber dam membrane with a slit central opening and a mesh material applied around the periphery of the central opening.

FIG. 9 is a cross sectional view of a field isolation rubber dam membrane with a slit central opening and an adhesive applied around the central opening on the operative side of the membrane with a release liner applied over the adhesive

FIG. 10 is a cross sectional view of a field isolation rubber dam membrane with a slit central opening and an adhesive applied around the periphery of the opening and on the tissue side of the membrane with a release liner applied over the adhesive.

FIG. 11 is a cross sectional view of a field isolation rubber dam membrane with a slit central opening and an adhesive applied around the periphery of the central opening on the operative side of the membrane

FIG. 12 is a cross sectional view of a field isolation rubber dam membrane with a slit central opening prepared in the membrane

FIG. 13 is an anterior field isolation rubber dam membrane with a mesh material applied around the periphery of the slit central opening

FIG. 14 is a close-up isometric view of the slit central opening with the mesh material applied around the opening

FIG. 15 is an isometric view of a posterior field isolation rubber dam with an adhesive applied to the operative site and a release liner applied over the adhesive. This dam has an integrally attached frame

FIG. 16 is an isometric view of the release liner of the dam of FIG. 15 being removed by finger pressure in order to expose the tacky adhesive around the central slit opening of the dam

FIG. 17 shows the dam applied to a posterior segment of teeth and a clinician in the process of applying a specialized cervical retraction rubber dam clamp to retain the dam and to retract the membrane around the operative site.

FIG. 18 shows the dam in place in the patient's mouth and the cervical retraction clamp retaining the rubber dam. This dam did not have to be stretched over an external frame because the dam was constructed with an integral frame attached during manufacture.

FIG. 19 shows a clinician applying a barrier material over the adhesive around the perimeter of the operative site in order to perfect the moisture seal around the operative site. The adhesive pre-applied to the dam attaches the material to the membrane

FIG. 20 shows the clinician light curing the barrier adhesive around the periphery of the operative site in order to polymerize the material and complete the barrier.

FIG. 21 is a side view of a posterior cervical retraction rubber dam clamp retracting a field isolation rubber dam to expose both the teeth and soft tissues prior to a barrier material being applied.

FIG. 22 is a top view of a posterior cervical retraction rubber clamp retracting a field isolation rubber dam to expose both the teeth and the soft tissues prior to a barrier material being applied.

FIG. 23 is an isometric view of two anterior cervical retraction rubber dam clamps retracting a short span field isolation dam in order to expose both the teeth and soft tissues for instrumentation.

FIG. 24 is a front view of two anterior cervical retraction rubber dam clamps retracting a short span field isolation rubber dam in order to expose both the teeth and soft tissues for instrumentation

FIG. 25 shows the completed application of a short span anterior field isolation rubber dam with an integrally attached frame

FIG. 26 shows a clinician removing the release liner from the tissue side of a field isolation rubber dam to expose the tissue adhesive prior to application.

FIG. 27 is an isometric view showing two anterior cervical retraction clamps retracting an anterior field isolation dam in a manner in which both the teeth and soft tissues are exposed for instrumentation.

FIG. 28 is a front view of the two anterior cervical retraction clamps retracting an anterior field isolation dam in a manner in which both the teeth and the soft tissues are exposed for instrumentation.

FIG. 29 shows a clinician using a visible wavelength curing light to photoactivate the polymerization process of the mucosal tissue adhesive through the semi-translucent rubber dam membrane in order to complete the application.

FIG. 30 shows an isometric view of a field isolation dam with an integral adhesive applied to the operative surface and a circular resilient integral frame being flexed to allow the field isolation dam to be applied more easily.

### DETAILED DESCRIPTION OF PREFERRED EMBODIMENTS

The general field isolation dams of the present invention may take a variety of forms or embodiments. They may be configured for either posterior segment isolation or anterior segment isolation. They may be membranes which are stretched over external frames which are separate devices or alternatively may have integral frames attached to them in the process of manufacture. They may have a fabric or mesh applied around the periphery of the slit-like central opening in order to micro-mechanically attach manually applied barrier material. Alternatively they may have adhesives applied around the slit-like central opening on the operative side of the dam in order to attach manually applied barrier materials. These adhesives may or may not have a release liner applied to the adhesive to keep it in a tacky state until the moment of use. In still another application, the dams may have a physiologically compatible mucosal tissue adhesive applied to the tissue side of the dam around the slit-like central opening to bond directly to both hard and soft tissues of the alveolar arch. In still another embodiment, the anterior or posterior field isolation dam may not be equipped with an integral mechanism for the application of a barrier adhesive, but instead rely on an adhesive integrally applied to the barrier material to be used during its manufacture which allows it to adhere directly to the dam and tissues. The adhesives applied to general field isolation dams will either have no water solubility or may have limited water solubility. These adhesives may either be pressure-sensitive adhesives or chemically activated adhesives or photoactivated adhesives.

### Applications of the Embodiments

A. A General Field Isolation Rubber Dam with Fabric or Synthetic Mesh Material for Application of Manually Applied Non-Adhesive Barrier Materials

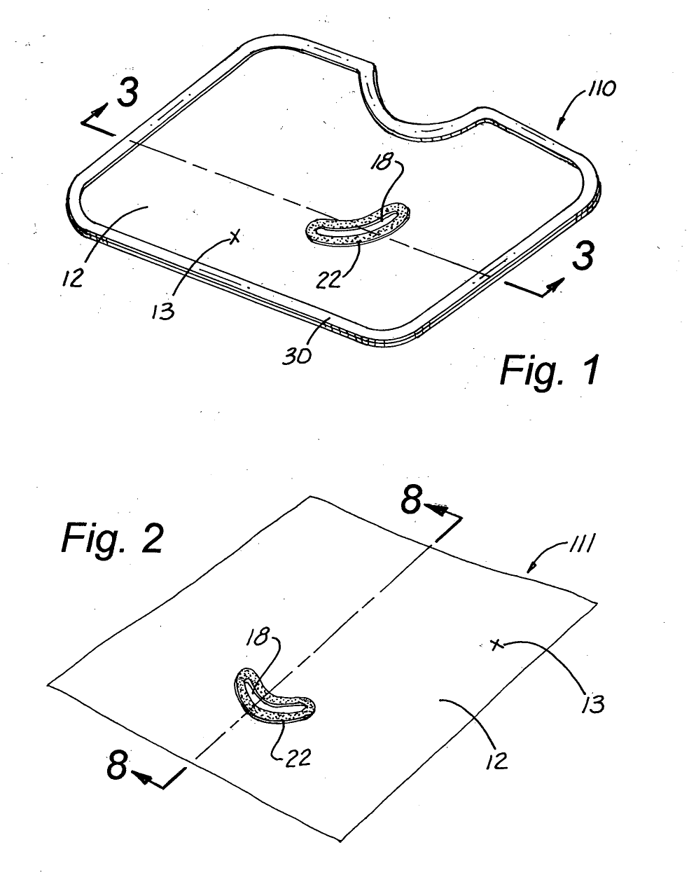

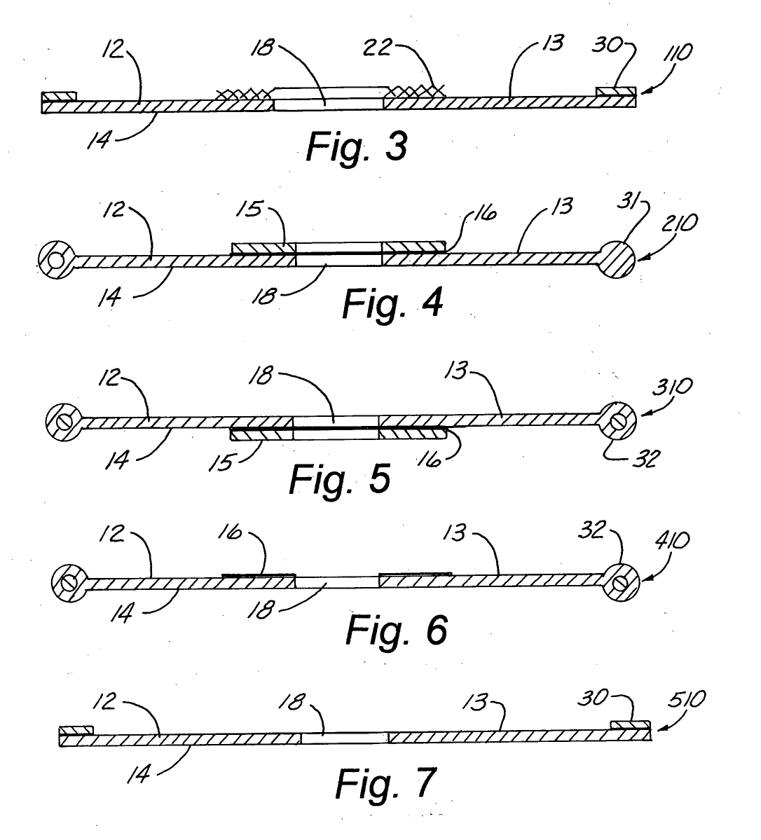

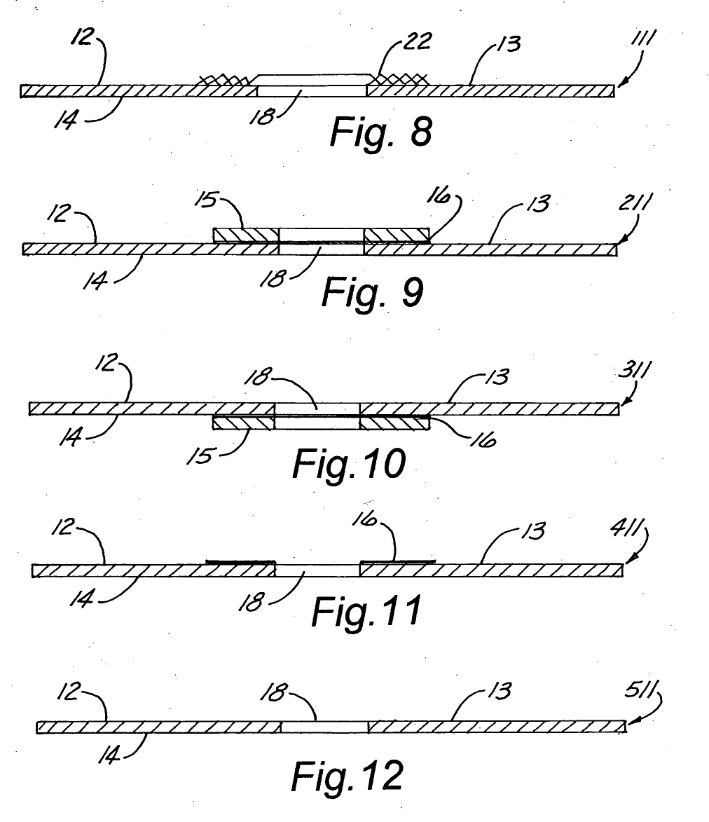

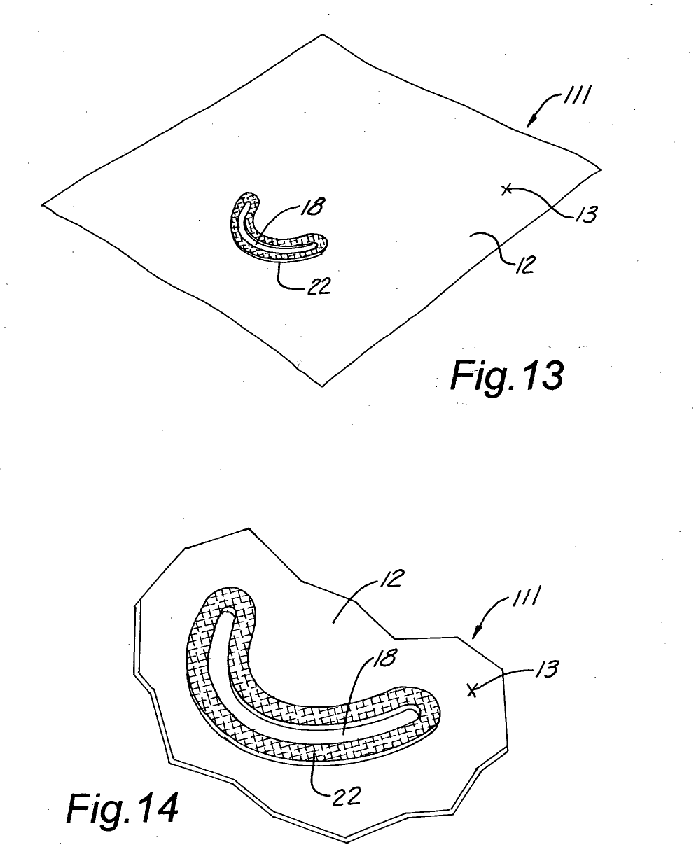

Illustrated in FIG. 1 and generally at 110, is an isometric view of a posterior general field isolation rubber dams with fabric or synthetic mesh material, for application of a manually applied non-adhesive barrier material, including an elastic membrane, 12, showing an integrally attached outer frame, 13, attached to the relatively square outer perimeter of the membrane and an oblong or elliptical open area, 18, in a central area of the membrane 12. Attached to the membrane, 12, on the operative side of the dam and located around the periphery of the opening 18 is a fabric or synthetic mesh material 22 approximately 2.5 to 3.0 millimeters in width, following the slit central opening 18 all the way around the periphery. This embodiment of the general field isolation rubber dam 10 allows the clinician to manually apply and bond a liquid, putty, gel, or paste elastomeric barrier material around the periphery of the operative perimeter of a dental work site. No adhesive need be applied to bond the polymeric barrier material to the dam 10, nor is there any need for a barrier material composition with an integrally applied adhesive within it to attach it to the dam 10, since the wetting and flow of the barrier material into the fabric mesh 22, creates micro-mechanical locking mechanism with the fully polymerized material interlocked into the microscopic retentive fibers of the mesh material 22. This design allows quite a number of different non-retentive chemical compositions of polymeric materials to be used with this dam in creating a moisture proof seal at the interface between the dam and the tissues to be isolated. This dam is primarily meant to be used with an applied barrier material. FIG. 2 and FIG. 13 show anterior configurations of a dam 111 with the fabric or mesh applied around the operative perimeter, but lacking an integrally applied external frame. This type of dam is stretched over an external frame which is a separate device. FIG. 3 and FIG. 8 are cross-sectional views of the dams discussed in this paragraph. FIG. 14 is a close-up view of the central slit opening 18 in the membrane, 12, of an anterior field isolation dam 111, with a fabric or mesh material 22 around the central opening

B. A General Field Isolation Rubber Dam with an Integrally Applied Adhesive Applied to the Operative Side of the Dam to Attach Manually Applied Barrier Materials Around the Periphery of the Operative Site

FIG. 4 and FIG. 9 show cross sectional views of another embodiment of a general field isolation dam 210 which is constructed with an integrally applied adhesive 16 applied to the operative side 13 of the membrane 12 around the perimeter of the slit central opening 18 in order to adhesively attach a manually applied barrier material directly to the dam. Covering the pre-applied adhesive 16 is a release liner 15 which is removed just prior to applying a barrier material to the dam in a clinical circumstance. The integrally applied adhesive 16 precludes the need for a barrier material to have its own adhesive within its composition in order for it to adhere to the dam. Furthermore, a dam with an integrally applied adhesive saves the clinician time in manually applying an adhesive around the periphery of the work site in order to prepare the dam to receive a barrier material. The chemical composition of the type of adhesive applied to the operative surface 13 of the membrane 12 is different than the material composition of tissue adhesives applied to the tissue surface 14 of a dam which directly bond to anatomical tissues. An adhesive applied to the operative surface 13 of a dam must adhere rubber dam membrane material and to a barrier material applied during treatment application. Since barrier materials may vary widely, these integrally applied adhesives may also vary widely. The most likely physical means of activation of such an adhesive would be a pressure sensitive adhesive or a chemically activated adhesive which activates upon exposure to water or components of saliva, but the use of a photoactivated adhesive cannot be ruled out. Whatever adhesive is used, it must either fall into a classification lacking in water solubility or alternatively have a limited water solubility in order for it to remain adherent during the duration of dental treatment. FIG. 6 shows an integrally applied adhesive 16 applied to the operative surface 13 of a rubber dam membrane 12 around a slit central opening 18 without a release liner present.

The Method of Applying A Barrier Material to a Field Isolation Rubber Dam With an Integrally Applied Adhesive to Adhere the Barrier Material to the Dam and Perfect the Moisture Seal

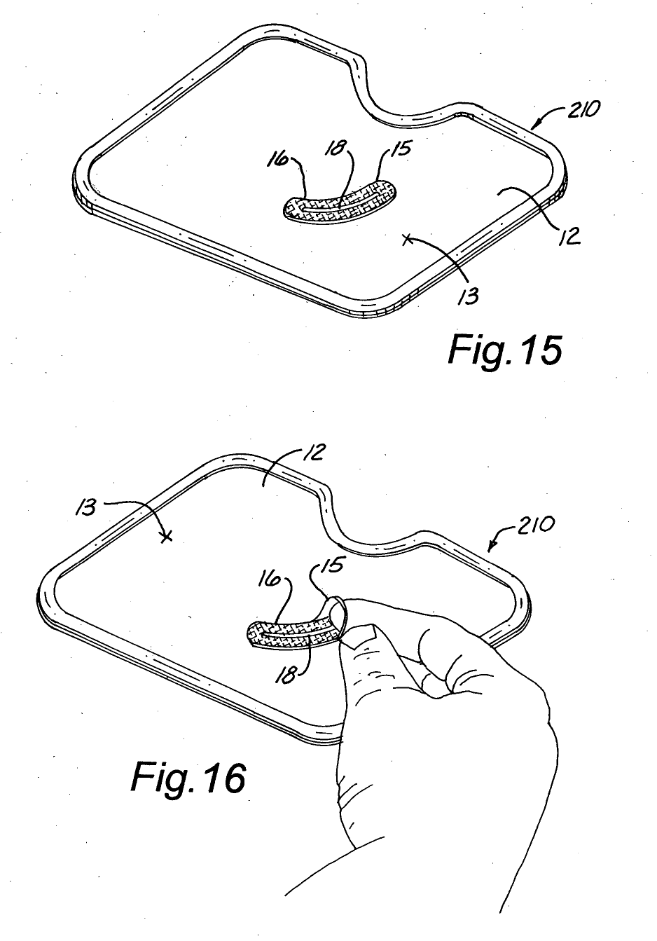

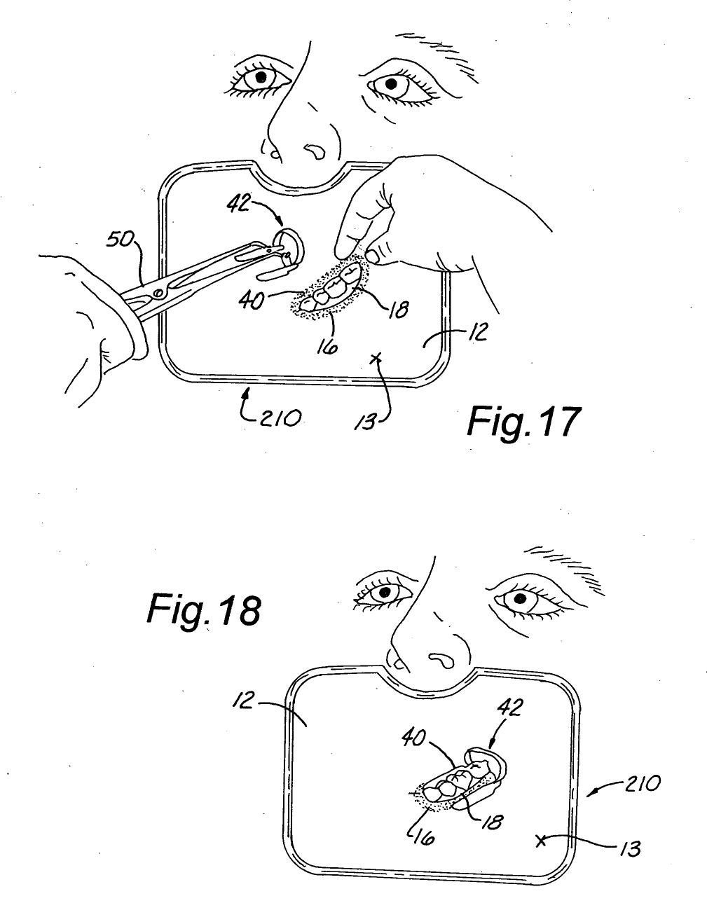

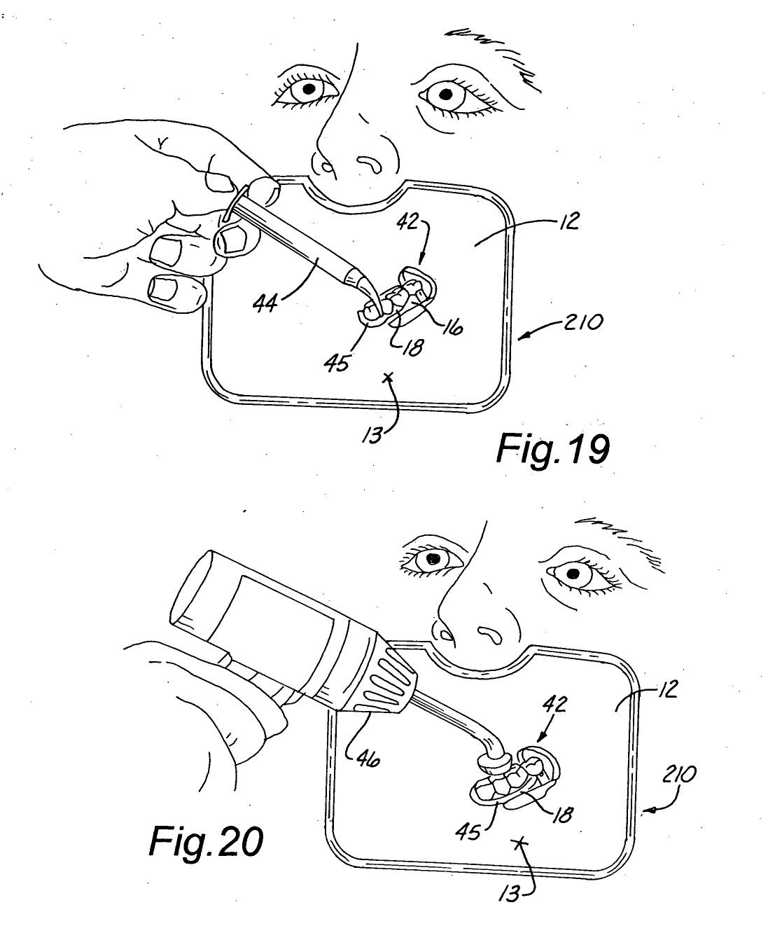

FIG. 15 shows a posterior field isolation rubber dam with an integral adhesive applied to the operative surface 13 of the elastic membrane 12 of a general field isolation rubber dam around the slit central opening 18 of the dam. The adhesive 16 is covered with a release liner 15. FIG. 16 shows a clinician removing the release liner 15 to expose the integral adhesive 16. FIG. 17 shows the field isolation rubber dam in place in a patient's mouth with a number of teeth 40 brought through the slit central opening 18. The integral adhesive 16 surrounds the periphery of the operative site. The clinician is placing a specialized cervical retraction rubber dam clamp 42 over the site with a rubber dam forceps 50 to clamp the last tooth in the arch and retain the dam with the rubber dam membrane retracted below the gum line. FIG. 18 shows the clamp 42 in place over the membrane 12 with the teeth 40 protruding through the central opening 18. FIG. 19 shows a clinician applying a barrier material 45 around the periphery of the central opening 18 over the integral adhesive 16. FIG. 20 shows the barrier material applied all the way around the periphery of the operative site. The clinician is curing the barrier material with a standard light curing lamp 46, since the type of barrier material applied utilizes a photoinitiated catalytic polymerization reaction.

C. The General Field Isolation Rubber Dams with Integrally Applied Mucosal Tissue Adhesives

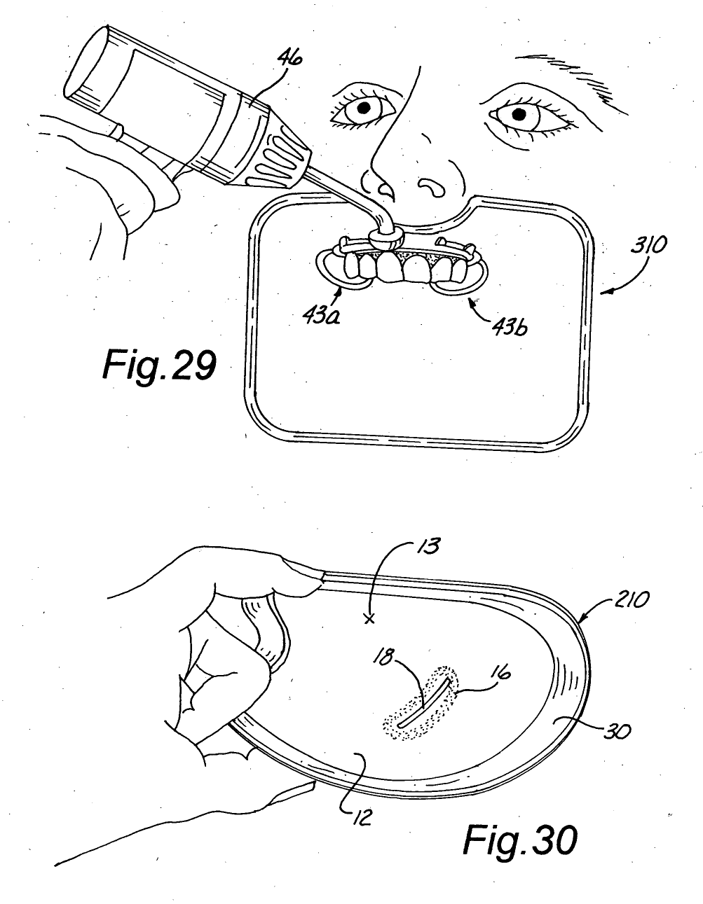

As shown in FIG. 5 and 10, an integrally applied tissue adhesive 16 is applied to the tissue surface 14 of the rubber dam membrane around the central opening 18. A release liner 15 is applied over the adhesive 16 to keep it in a tacky state until application. This embodiment allows a general field isolation rubber dam with a pre-applied mucosal tissue adhesive to bond the tissue side 14 of the elastic membrane 12 around the perimeter of the operative site directly to the hard and soft tissues of the alveolar arch around the dental work site. Integrally applied tissue adhesives are described in detail under the section pressure sensitive adhesives or non-pressure sensitive adhesives. These tissue adhesives may either be pressure-sensitive adhesive, chemically activated adhesives, or light cured adhesives. They may be covered with a release liner or alternatively may not have a release liner applied. While FIG. 4 and FIG. 9 show cross sectional views of field isolation rubber dam membranes with physiologically compatible tissue adhesives applied to the tissue side of dams, FIG. 29 shows a clinician removing the release liner 15 from the tissue side 14 of a general field isolation rubber dam to expose the tissue adhesive 16 around the central opening 18 of the operative site.

D. General Field Isolation Rubber Dams with a Membrane Flange Surrounding the Central Opening

FIGS. 7 and FIG. 12 show in cross section general field isolation rubber dams with an elastic-only inner border, i.e., without the mesh material or without an integrally applied adhesive that may be used alone without any applied barrier material or may be used with a barrier material which adheres to the membrane by an adhesive integrally applied within the composition of the barrier material itself. Alternatively, a clinician may manually apply an adhesive to attach a barrier material to the membrane or may directly apply a physiologically compatible mucosal adhesive to the tissue side of the dam to bond directly to the tissues.

General Field Isolation Rubber Dams with Integrally Attached External Frames

Two types of dams are described in this disclosure with regard to the manner in which external frames are applied around the periphery of the membrane. In general, the prior art dams are membranes which do not have integral frames. These dams are stretched over frames which are separate devices which have ‘nibs’ which ‘catch’ the stretched rubber in order to restrain it and retract the soft tissues of the lips and cheeks. In FIGS. 3 through 7 various types of rubber dams with integrally applied frames are depicted, which are applied to the membrane at the time of manufacture of the dam. In general, integrally applied frames may either be elastic, malleable, resilient, or rigid. The integral frame that is attached to the surface of the membrane 30, as illustrated in FIG. 3 or FIG. 7, may be a molded plastic or composite frame or may alternatively be made of metal. It may be attached with adhesive or alternatively by a heat melt or other process. An elastic integral frame 31 may be injection molded at the time of molding of the membrane itself, as in FIG. 4. Alternatively, the integral frame may have a wire or plastic or composite member 32 imbedded in it at the time of manufacture, as depicted in FIG. 5 or FIG. 6, in order to impart the desired qualities to the external frame. Whether the integral frame is elastic, malleable, resilient, or rigid is a choice that the manufacturer of the device makes, depending on the type of clinical effect intended by the contribution of the type of retraction and control of the rubber dam membrane around the periphery of the membrane.

Although the integral frames depicted generally in this disclosure are rectilinear, circular or oval, or elliptical, other shaped frames would serve the purpose as well. In particular, a circular frame, if the central opening is placed with care in a certain configuration, can be applied to either anterior applications or alternatively posterior segment applications by rotating the frame until the central opening is oriented for a selected application. This universality of the circular frame makes this configuration particularly attractive for marketing and manufacturing purposes. In addition, a resilient and deformable frame that is flexed into a “U” shape allows the dam to be applied more easily by decreasing the stretching of the dam between the operative field and the external frame, thus decreasing the tensile forces of the stretched membrane. FIG. 30 shows a resilient circular field isolation dam 210 with the external resilient frame 30 being flexed into this “U” shaped configuration. Also shown is the central opening 18 with an adhesive applied around the opening on the operative surface 13 of the rubber dam membrane.

The True Rubber Dam Versus Intraoral Rubber Dam Barrier Devices

The true prior-art rubber dam in dentistry is composed of an elastic membrane generally 6″×6″ square of varying thicknesses for adults or a 5″×5″ square elastic membrane for pediatric applications. The prior-art rubber dam is generally stretched over an external rubber dam frame device which engages the rubber dam membrane by stretching the membrane over ‘nibs’ to attach it the framework. Reciprocal forces applied by the stretched membrane to the framework hold it in place and retract the lips, creating increased access to the oral cavity. This is largely a circumferential type of retraction in all directions. There are a number of products emerging in the contemporary marketplace which purport to be rubber dams with integrally attached frames. Some have integral frameworks located wholly outside of the mouth which are attached to a rubber dam membrane roughly paralleling the function of a true rubber dam/rubber dam framework assembly and should be rightfully called an extension of the true rubber dam prior art. Others have integral frameworks which are not external to the oral cavity as defined by the vermilion border of the lips and/or do not completely retract the lips in a 360 degree manner as in the true prior art, and therefore should not be defined as true rubber dams in the prior art context. Hence, any framework which does not retract the lips from at least the vermilion border of the lips or outwardly in a radial direction from this location and/or retract the lips in a true circumferential manner, should not be considered a true rubber dam in the true prior art sense but should be classified as an intra-oral barrier or isolation device. Any rubber dam lacking a true 360 degree circumferential retractive quality and therefore falling within the stated definition of an intra-oral barrier device, but designed and fabricated with respect to the principles of general field clinical isolation and having generally the same material handling characteristics as the rubber dams of this disclosure, should be considered within the spirit and scope of this disclosure and not a true departure of novelty from the devices described herein. By definition, the foregoing description and drawings comprise illustrative embodiments of the true rubber dam but abbreviated versions of rubber dams which utilize the same methods and have the same material handling characteristics should be considered within the spirit and scope of this disclosure.

### Areas of Particular Applicability of the General Field Isolation Rubber Dams Without Operative Inserts

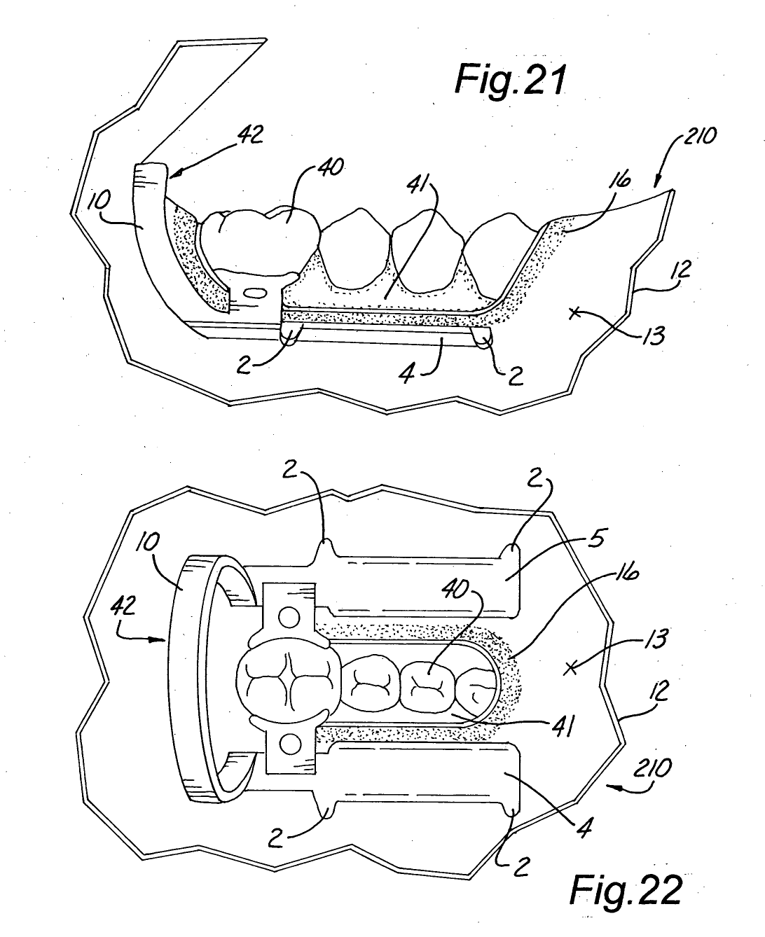

The general field isolation rubber dams of the present invention without operative inserts have some limitations that general field isolation rubber dams with operative inserts do not have, but they will be an economical adjunct to field isolation and will find their own market niche as an isolation modality. In general the field isolation dams without operative inserts are most applicable in straight or linear segments of the alveolar arch, particularly the posterior segments. The dams may be stretched from second molar anterior to canine, since this is invariably a linear application, and have great efficacy to the clinician. This typical application can be seen in FIGS. 15 through 20, and an enlarged side view in FIG. 21 and another enlarged top view in FIG. 22. FIG. 15 shows a posterior segment dam with an adhesive 16 covered with a release liner 15. FIG. 16 shows the release liner 15 being removed, FIG. 17 shows the dam placed over a posterior segment, FIG. 18 shows the dam in place over the segment with a cervical retraction clamp 42 retaining it FIG. 19 shows a barrier material 45 being applied over the adhesive 16, FIG. 20 shows the completed barrier material application 45 being light cured with a curing light 46 to polymerize it. In FIG. 21, the field isolation rubber dam with an adhesive 16 applied around the central opening 18 on the operative side 13 of the darn is shown from a side view. Also shown is a posterior cervical retraction clamp 42 which retracts the rubber dam to expose both the plurality of teeth 40 and associated soft tissues 41 (the gums). FIG. 22 shows all of these features from a top view.

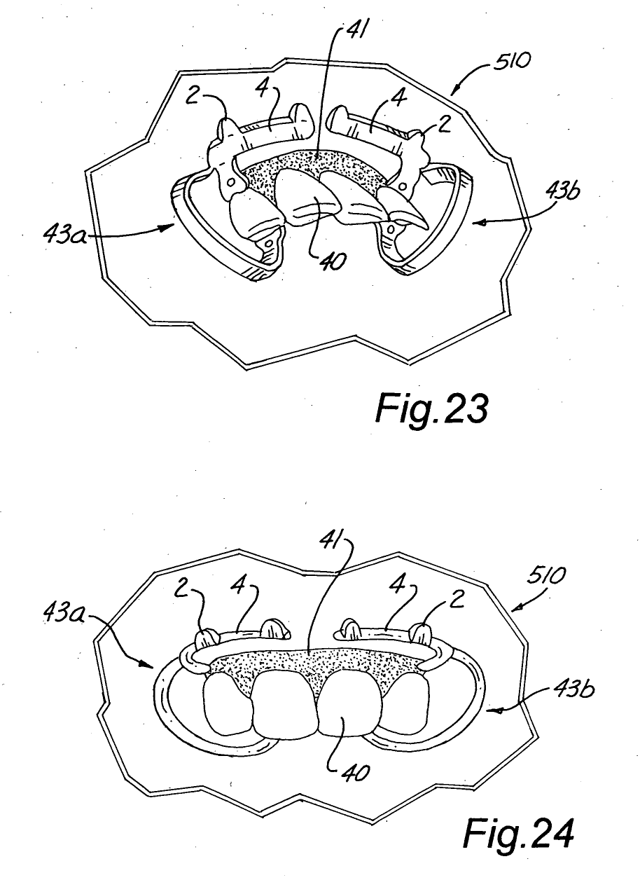

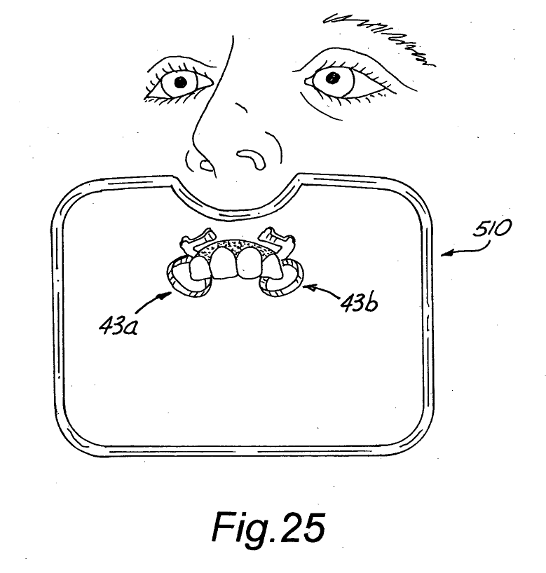

In addition to linear posterior segment applications, these field isolation dams without operative inserts can also be applied to the more curved portions of the anterior segments, with the most effectiveness if only short segments of the alveolar arch are isolated, such as up to four teeth at a time. FIGS. 23, 24, and 25 show a short span isolation of an anterior arch segment. FIG. 23 is an isometric view of four teeth 40 and associated soft tissues 41 which have been brought through the central opening 18 of a field isolation rubber dam. Left and right cervical retraction rubber dam clamps, 43a and 43b have been placed to retain the dam and to retract the dam. FIG. 24 shows the same elements from a frontal view. FIG. 25 shows the completed application, with the dam in place and the operative site ready for instrumentation.

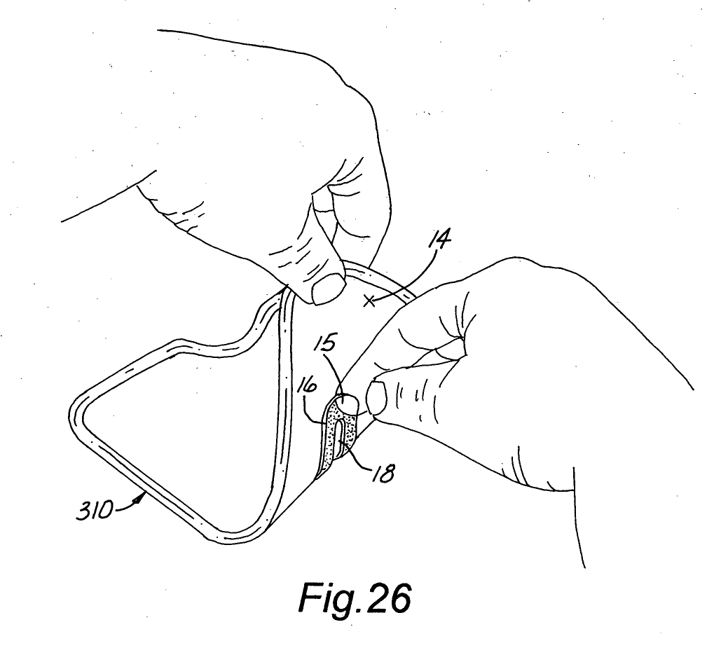

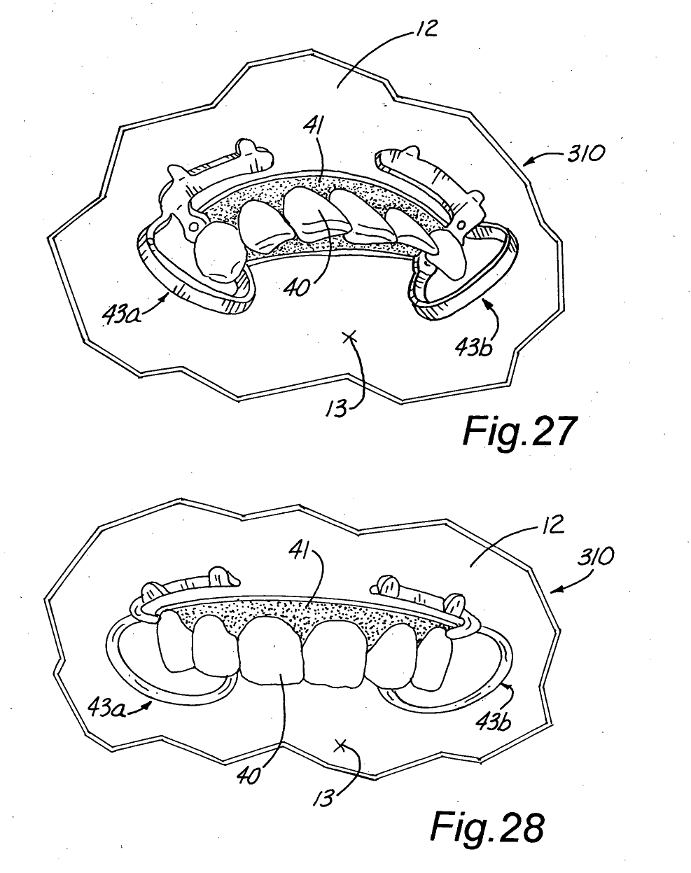

Due to the curvature of the anterior alveolar arch, the linearly stretched rubber dam on the lingual side of the isolated site begins to separate from the concave curvature of the lingual gingival tissues, thereby leaving an open gap for the percolation of fluids. The longer the attempted isolation of an anterior arch segment, the more this effect intensifies. In cases with a relatively broad anterior segment or prominent lingual shelf, a fairly acceptable result may be obtained with isolation of only the six anterior incisors, particularly if an integral tissue adhesive is employed or a relatively tenacious manually applied barrier adhesive. FIG. 26 through FIG. 29 show the application of this longer anterior isolation dam. In FIG. 26, the release liner 15 is removed from a mucosal adhesive 16 surrounding the central opening 18 in the dam. FIG. 27 shows the dam in place over the anterior segment with the teeth 40 and associated soft tissues 41 brought through the central opening. The dam is retained and retracted by left and right anterior cervical retraction clamps 43a and 43b. FIG. 28 shows these elements from a frontal view. In FIG. 29, a clinician is using a visible wavelength light curing lamp 46 to light cure the tissue adhesive through the semi-translucent rubber dam membrane in order to activate the adhesive to its maximal adherence to the alveolar tissues. In cases where longer anterior arch segments are to be isolated for prosthetic procedures, general field isolation rubber dams with malleable operative inserts, described by this author in another disclosure, are indicated.

### Operative Dentistry

General field isolation dams will be of great benefit in many operative dentistry procedures that cannot be accessed with the conventional technique. The isolation of grossly carious teeth that no longer have intact clinical crowns due to their complete breakdown by the disease process will be able to be isolated with this technique. If the severely carious teeth are in the most posterior placement within an arch, a specialized design of the general field isolation dam will aid in the isolation of this specialized circumstance.

In addition, teeth with deep subgingival caries; either facial or lingual deep Class Vs and also deep interproximal Class IIs are excellent candidates for this application.

Porcelain laminate veneers, which require subgingival access for preparing the margins of the preparations below the gum line and for the packing of retraction cord in the gingival sulcus, and later to adhesively bond the veneers to the enamel or dentin, are perfectly served by this technique. In these procedures, the adhesive bonding is very technique-sensitive and the strength of the bonding of the porcelain veneer to tooth structure is greatly enhanced with the quality of dry field that rubber dam application provides. The indirect techniques of porcelain and composite and CAD CAM computer generated ceramic inlays, onlays, and crowns are also bonded applications with this sensitivity for dry field technique that only a rubber dam can satisfy.

### Pedodontics

Children will adapt to an easier rubber dam technique with less flossing and difficulty in the application phase. Teeth with clinical crowns that are so broken down to the level of the gum line that a conventional rubber dam may not be applied will be excellent candidates for the application of the general field rubber dam. The placement of stainless steel crowns and plastic provisional crowns for the young child will be well served by the technique.

### Endodontics

The conventional rubber dam technique is the application of choice in endodontic procedures, except in the exceptional circumstance where isolation is impossible with the conventional technique. Single or multiple grossly carious teeth without clinical crowns qualify as indications for general field isolation during endodontics. An intact barrier material application creating a competent seal around the entire operative perimeter is universally required to prevent any endodontic files or components from being swallowed or aspirated. In addition, all files used for endodontic applications with the general field isolation dam should be ligated with dental floss to insure a second line of defense to the problem of aspiration.

### Periodontics

Periodontal procedures have universally been accomplished without any rubber dam involvement and it is anticipated that the changes to clinical practice in this area will be resisted or remain largely unchanged with this new technique. One possible benefit to the periodontist, however, will be in the area of application of medicaments, which can be diluted by saliva and subsequently be less efficacious in their anticipated clinical effect. In addition, medicaments and chemical agents applied to the periodontium often trickle down the patient's throat without isolation, causing discomfort to the patient. The general field isolation dam, with an intact barrier seal would prevent the bitter taste of such agents and as such make the patient more comfortable during treatment.

### Prosthodontics

The general field isolation dams of the present invention will significantly improve the quality of prosthodontic treatment. The major shortcoming of the conventional rubber dam technique is that it generally provides access to instrumentation of the clinical crowns of the teeth, thereby preventing any subgingival access for instrumentation and ruling out prosthetic procedures from rubber dam isolation. With this new technique, all phases of prosthetic procedures, from the preparation phase, through the retraction and impression phase, to the fabrication of provisional temporary restorations, and the final seating of the prosthesis will be benefited. This is true whether the type of restoration to be fabricated is a single crown, multiple crowns, conventional bridge, Maryland Bridge, onlay, ¾ crown, anterior porcelain fused-to-metal crowns, porcelain jacket crowns, CAD CAM computer generated ceramic crowns, onlays, implant-supported crowns or bridges, base-ups for badly deteriorated teeth in the preparation phase of crown preparation cast post and core fabrication and placement, and other future prosthetic procedures as of yet to be thought of.

### Implantology

General field isolation dams will have a significant effect on the placement of implant components in prosthetic procedures which follow the healing process of the implant. These new techniques require the handling and placement of minute components to complete the procedures. This raises the possibility of implant components being dropped accidentally during the procedures and subsequent swallowing or aspiration by the patient. Current procedures in this area are routinely performed without the use of the rubber dam. The general field isolation rubber dam may be of great value in protecting the patient and the dentist from this unpredictable unfortunate risk that is an inherent byproduct of this new treatment modality. It is an absolute requirement of the dentist using the general field isolation dam in circumstances where small components are used, to apply the general field isolation meticulously and make sure that a barrier material is applied to hermetically seal the entire circumference of the operative perimeter at the dam-tissue interface. The dam must be monitored by the clinician at all times to make sure that the barrier remains intact in order to realize all of the benefits of the use of the rubber dam in controlling the risks inherent in these techniques. As a second line of defense to ingestion or aspiration, small implant components should be ligated during try-in and during placement.

### CAD-CAM and The Computer Generated Dental Restoration

CAD-CAM (computer aided design and computer integrated manufacture) is the creation of dental restorations almost instantaneously with the use of an imaging unit to take digital impressions of the contours of a prepared tooth and surrounding teeth and then computer generate the necessary dimensions and contours of a completed restoration, and then mill the specified restoration from a block of ceramic material in a manner of minutes. This process requires a process of the sintering of a metal power onto the preparation or indirectly onto a model in order for the imaging to properly detect the contours of the preparation and surrounding teeth for insertion of the data into the computer. In order to apply the layer and obtain a quality digital image, saliva and moisture must be eliminated from the operative site. The general field isolation rubber dam will be of great value in isolating the operative field for this technique of optical imaging as a substitute for conventional impression techniques. In addition, the general field isolation will serve equally well in the insertion phase and bonding of these ceramic restorations in place once they are fabricated by the CNC milling process.

### A Brief Discussion of Modified Field Isolation Rubber Dam Clamps and Their Interaction with General Field Isolation Rubber Dams

General field isolation rubber dams without operative inserts must rely on externally applied retraction devices in order to retract and retain the dam. The effective design of rubber dam clamps for general field isolation of the operative site must fulfill three major requirements in order to be effective: First, they must allow the rubber dam membrane to come into intimate contact with the teeth and soft tissues of the alveolar arch in order to effectively seal the tissue-dam interface in order to prevent the percolation of fluids through to the operative work site (i.e. the creation of an impermeable seal at this interface, if possible); second, they must retract the rubber dam membrane in a cervical direction to expose not only the teeth, but also the associated soft tissues, for adequate visibility and ease of instrumentation below the gum line; and third, they must support the rubber dam from displacement by the tensile forces exerted upon it by the stretching of the resilient material by the rubber dam frame. The field isolation clamps, while exposing both the teeth and soft tissues, must facilitate the prevention or elimination of an opening or gap for the percolation of fluids, thereby reducing the effectiveness of the membrane as an isolation barrier and compromising the integrity of the operative site.

FIGS. 21 and 22 illustrate the relationship between a posterior cervical retraction rubber dam clamp 42 and a general field isolation dam 21 0 of the present invention. The clamp 42 attaches to the base of a tooth 40 near the gum line and includes a pair of extended arms 4,5. A transverse spring arch, 10, provides tension to the reciprocally retain the clamp on the tooth. The two arm extensions, 4,5 extending on each side of the alveolar arch and row of teeth, have rubber dam attachment nibs 2 which allow variable attachment of the rubber dam to the clamp to adjust the dam with regard to contact with the alveolar arch.

FIG. 23 and FIG. 24 show left and right anterior cervical retraction clamps 43a and 43b with similar features, except there is only a single extension arm, 4 on each of these clamps. Rubber dam attachment nibs, 2 are located on the extensions. All other features are similar to the posterior clamps.

Contraindications and Precautions for Use of the General Field Isolation Rubber Dam

The first contraindication to the use of the general field isolation rubber dam is the circumstance in which a conventional rubber dam technique can be employed. In such a circumstance the conventional dam usually should be used as the isolation technique of choice. The general field isolation rubber dam is indicated in two general circumstances. First, when the conventional rubber dam technique absolutely cannot be applied, and second, in circumstances where the practitioner needs to employ a rubber dam for good technique, but also needs to instrument below the gum line for completion of the procedure to be undertaken.

Allergenicity to any component of the general field isolation rubber dam is a contraindication of paramount importance to the use of a general field isolation rubber dam. Any general field isolation dams manufactured of latex will have the same properties of allergenicity as any standard medically approved latex product, including commercially distributed latex rubber dams in use in clinics and dental offices in the United States and abroad. Standard precautions such as questioning the patient for a general atopic susceptibility to allergens, and specifically for prior contact dermatitis or anaphylactic allergic reactions to latex must be undertaken. Fortunately, the likelihood of allergic reactions to latex is extremely low and therefore has been widely approved by the Food and Drug Administration as an acceptable composition for construction of medical devices of all type, including rubber dams, medical and surgical gloves, barrier products, and other medical devices.

While the construction of many general field isolation rubber dams will be of latex, other polymeric materials may be substituted in certain circumstances for their alternative physical characteristics or for properties which facilitate manufacturing techniques required to produce the general field isolation dams in quantities and at a price as to make them commercially viable products in the marketplace. Silicone is one such possible substitute, which may be quite desirable in the manufacture of general field isolation dams because it has virtually no known properties of allergenicities and it may be injection molded, which may be indispensable in the rapid production of the dams which will have the added insert. Other commonly used polymeric materials such as vinyl, or nitrite, or neoprene, or many others too numerous to be listed may also be substituted.

Other contraindications to the use of the general field isolation rubber dam are patients who are highly anxious and are prone to panic attack, or who experience claustrophobia with the use of a rubber dam, or have uncontrollable tongue thrusting movements, or involuntary lack of control of muscular movements, or breathing difficulties such as asthma, chronic sinusitis, chronic obstructive pulmonary disease, emphysema, or other obstructions which would compromise their breathing with a rubber dam in place. In addition, prior to suturing the clinician must ascertain if there is any blood dyscrasia which would cause excessive bleeding during a surgical procedure. The very small child should be evaluated with respect to all these contraindications and precautions and also for any anxiety limitations to the use of the medical device from a pediatric standpoint.

Any clamps use to retain the dams must be sterilized and ligated before use. Also, if any intricate components are to be used with the field isolation rubber dams, they also should be ligated prior to use as a second line of defense to ingestion or aspiration. Such devices as endodontic files, implant components, hand held pin wrenches, to name a few must be so ligated prior to use. Rubber dams which are fabricated as intraoral devices should either have a component of the dam designed external to the oral cavity for quick and easy removal of the dam by the clinician or alternatively should be securely ligated for quick and easy removal if necessary. Judicious attention to the maintenance of an intact barrier seal must be foremost on the clinician's list of priorities during instrumentation, particularly in cases where intricate small components or instruments are being utilized. There is no substitution for the exercise of proper clinical judgment in the use of any device or implementation of any method in the dental art at any time.

### General Field Isolation Rubber Dams with Integrally Applied Barrier Adhesives

Pressure-sensitive Adhesives

General field rubber dams may be constructed with barrier adhesives pre-applied in their manufacture. One classification of adhesives of potential application to the general field isolation rubber dam method of isolating tissues are generally are known as pressure-sensitive adhesives, also referred to as PSA's. Pressure sensitive adhesives are viscoelastic materials which, in solvent-free form, remain permanently tacky and will adhere instantaneously to a wide variety of solid surfaces as a result of application of very slight pressure. A PSA is usually applied in the form of a solvent—free coating on a “backing”, often a flexible backing—in this application to the polymeric surface of the general field isolation rubber dam. The PSA attaches the “backing” material (i.e., the flange of the dam), to a “receptor” (i.e., the surface to which the PSA is to adhere to with the application of pressure to the intra-oral mucosa or enamel of the teeth).

The PSA must have characteristics which satisfy the requirements of the application intended-in this case of an intra-oral isolation device. First, it must adhere to the receptor, in this case the hard tissues of the teeth and also the gingival and mucosal tissues, with sufficient t peel strength' which resists removal from the receptor for the purpose intended. Second, it must adhere to mucosal tissues in the presence of oral fluids being present upon application and continue to adhere tenaciously in spite of being in an environment which is bathed in oral fluids and water during the attachment phase. Third, it must be able to be removed cleanly from the receptor without leaving a residue of adhesive and without causing undue discomfort, tissue damage, or without rupturing the backing material. Fourth, it must be hypo-allergenic or not irritate the mucosal epithelium upon application or in any manner after application.

It is important that the adhesion to the oral tissues is low enough to allow the strip of material to be easily removed by simply peeling off the strip of material using only finger pressure when the dam is removed at the completion of the treatment session. The peel force required to remove the strip of material, which will typically be about ½ cm in width from the oral surface is from about 10 grams to 15 grams per side of oval operative perimeter. Since the removal of the oval perimeter requires both sides to be removed at the same time, this range varies from 20 grams to 30 grams as the dam is stripped off. A wider range of 0 grams to 50 grams is possible due to inconsistencies in the application of the dam and the flexural stiffness of the wire insert within the dam.

There are a variety of compositions of mucosal adhesives that would be suitable as integrally pre-applied barrier substances. Suitable limited water solubility polymer adhesives include: hydroxy ethyl or propyl cellulose. In addition polymer adhesives lacking water solubility include: ethyl cellulose and polyox resins. Other possible adhesives suitable for integral application is polyvinylpyrrolidone; or still another is a composition of Gantrex and the semisynthetic, water-soluble polymer carboxymethyl cellulose. The widely used cyanoacrylates; methyl, dimethyl, ethyl, butyl, octyl and other are compositions compatible with mucosal tissue adherence. These PSA's can comprise a base polymer alone or a mixture of base polymer and one or more additives such as plasticizers, tackifiers, fillers, stabilizers, and pigments. This list of PSA's does not exhaust the range of possibilities of alternatives for integrally applied adhesives, and should not serve to limit the options available for this application. Further descriptions of PSAs compatible to this application may be found in The Encyclopedia of Polymer Science and Engineering, (New York, John Wiley & Son, 1988;) or the Handbook of Pressure-Sensitive Adhesive Technology, Ed. Don Satas (New York, Van Nostrand Reinhold Co., Inc. 1982) or A. H. Flanagan, Adhesives Technology Handbook (Park Ridge, N. J., Noyes Publications, 1985), or many other Journals or publications of polymer science.

The integrally applied adhesive substance may be in the form of a viscous liquid, paste, gel, solution, or other suitable physical form in a substantially uniform continuous coating around the inner peripheral latex flange of the operative work site, on the side of the rubber dam designated for direct contact with the hard and soft tissues of the operative site. The adhesive is covered by an easily removable covering, called a release liner, which keeps the adhesive in a maximally tacky state until it is required for use. At this time, the release liner is stripped off, exposing the adhesive, and applied to the receptor.

The release liner may be composed of a single piece of flexible or rigid material or from two overlaying pieces of said material such as a typical adhesive strip bandage design. The release liner is preferably comprised of any material which exhibits less affinity for the adhesive coating than the adhesive substance exhibits for itself, and strips off with finger pressure to expose the adhesive film that it is adhered to. This liner may be comprised of a rigid sheet of material such as polyethylene, paper, polyester, or other material which is coated with a non-stick type of material. The release liner material may be coated with Teflon®, wax, silicone, fluoropolymers, or other non-sticky coating. FIG. 15 shows a rubber dam with an adhesive 16 applied to the operative surface 13 of a field isolation rubber dam and covered with a release liner 15, while FIG. 16 shows a clinician removing the release liner 15 to expose the underlying adhesive. FIG. 29 shows an adhesive 16 applied to the tissue surface 14 of a field isolation rubber dam with a clinician removing a release liner 15 to expose the tacky surface of the adhesive.

General Field Isolation Rubber Dams with Integrally Pre-applied Pressure Sensitive Adhesives Acting Primarily as Barrier Materials (Primarily Non-Retentive)

General field isolation rubber dams with pre-applied mucosal tissue adhesives acting as barrier agents to refine the integrity of the moisture seal between the patient's oral cavity and the dentist's operative work site will save time and effort for the clinician when applying the rubber dam for use in a procedure.

In the case of PSAs used primarily as barrier materials the general tackiness and retentive adherence of the flange of the dam by the adhesive need not be strong enough to retain the rubber dam in place, since mechanical forces of applied rubber dam clamps and the rigidity of the wire insert are the principal means of retention of the dam. The applied adhesive need only attach the flange of the rubber dam to the hard and soft tissues with enough retentive force to prevent breakage of the moisture seal by frictional forces created by the lips, teeth, tongue, and other extraneous forces applied during a typical treatment session.

### Non-Pressure Sensitive Adhesives

Other classifications of tissue adhesives are polymeric compositions which are designed to adhere to hard and/or soft tissues of the human body (fibrin glues an methylacrylates are two commonly applied categories, but other compositions may also be substituted), but need an initiator to activate the process of polymerization and adherence to the receptor, which is the tissue surface of the intended application. Generally, initiators fall into three categories of chemical, thermal, and photopolymerization. Tissue adhesives which are chemically activated may be initiated with chemicals applied to them or chemicals naturally present in the biological tissues of the application. Water is one chemical which may be applied directly to a tissue adhesive by the clinician or may be found naturally in saliva. Hence, there are biologically compatible tissues that may be selectively activated by water. Other tissues adhesives may be activated by the application of or contact with other chemicals, such as components of human saliva or even proteins present in on the epithelial surface of the gingiva or mucosal tissues in the oral cavity or by proteins present in the enamel pellicle coating the surfaces of the teeth. Still other tissue adhesives are designed to be photoactivated by the exposure to light of a certain intensity and wavelength. Tissue adhesives activated by any of these methods are candidates for integral application to the general field isolation rubber dam.

General Field Isolation Rubber Dams with Integrally Applied Photoactivated Tissue Adhesives

General field isolation dams with integrally applied tissue adhesives requiring photoactivation for adherence to hard or soft tissues of the oral cavity or other extraoral tissues will be of great efficacy to the clinician in establishing adherence of the tissue-dam interface as a barrier to refine the moisture seal of the application or as retention of the dam to the tissues to be isolated or combination applications of barrier/retention simultaneously. General field isolation dams may be constructed to enhance the translucence of the polymeric membrane so that a photoactivated tissue adhesive which is applied to its surface may be activated by shining a visible wavelength curing light through the dam in order initiate polymerization and adhere the dam to the tissue surface. FIGS. 26 through FIG. 29 illustrate the process of applying this type of dam. In FIG. 26, a release liner 15 is removed from the adhesive 16 surrounding the central opening 18 in the dam. In FIG. 27, an isometric view shows a plurality of anterior teeth 40 which have been brought through the central opening 18 of the dam and left and right anterior cervical retraction clamps, 43a and 43b, which have been applied over the rubber dam to retain it over the application and retract the rubber dam membrane cervically to expose both the teeth 40 and the associated soft tissues 41 for instrumentation. FIG. 28 shows these elements from a frontal view. The tissue adhesive is not visible in these views because it is on the tissue side of the membrane out of sight. FIG. 29 shows a clinician using a visible wavelength light curing lamp 46 to light cure the tissue adhesive through the semi-translucent dam. The ideal photoactivated tissue adhesive for this application has a slightly tacky adherent surface when the release liner 15 is removed and is somewhat adherent to the anatomical structures in the preparation stage. Once in place and in contact with the tissues to be isolated, a visible wavelength light curing unit activates the adhesive by shining light through the semi-translucent dam, curing the tissue adhesive and making it intimately compliant to the surface and creating a competent adhesive-tissue interface to seal the dam from moisture contamination. (Note: the degree of tenacity of retention of the adhesive-tissue interface is discussed under the pressure-sensitive adhesives discussion of peel strength and is the same requirement in both types of bonding of adhesives.) The same requirements of the adhesives applied in this type of application, such as being suitable in a moist environment and insoluble to moisture in saliva and other water-based liquids applied during a procedure, as indicated in the discussion of pressure-sensitive adhesives is applicable to the application of these adhesives also.

### Polymeric Membrane Specifications

General field isolation dams of the present invention for dental purposes will consist generally of 6″×6″ square polymeric membranes for adults or 5″×5″ square membranes for children, with generally accepted specifications of thicknesses according to accepted dental standards, with the following values: thin 0.006″; medium 0.008″; heavy 0.010″; and extra heavy 0.012″. While these standard values will most likely be found to be the most useful, any general field isolation rubber dam manufactured with the parameters of 0.004″ to 0.100″ should be considered to be within the area of general filed isolation dams of the present invention.

The membranes may be manufactured of a wide variety of polymeric or thermoplastic materials such as latex, neoprene, silicone, polyethylene, vinyl, polyurethane, or other polymeric or thermoplastic materials of suitable qualities, so long as the membranes demonstrate the physical handling characteristics necessary for successful clinical field isolation of the dental operative site. Some of the typical parameters of physical characteristics of materials required of these polymeric membranes are: range of tensile strength 2,500-10,000 psi; elongation at break 400-1,110%; hardness (shore) 60-100A; and notched resistance to tearing 100+ kilonewtons per meter. These characteristics of physical materials are general guidelines only. Individual materials may vary depending on their composition and physical attributes, but still be considered to be within the spirit and scope of this invention.

The foregoing embodiments described herein may vary somewhat due to restrictions in manufacturing processes, the financial constraints of producing an end product at a cost which is competitively priced to the end-user, and preferences of form or usage, but still fall within the spirit and scope of this disclosure. Simple substitution of material composition, such as the substitution of polyurethane or nitrile or silicone or neoprene or vinyl or other elastomeric materials for the standard latex membrane should not be considered a change in novelty. Nor should the departure from an elastomeric material, such as a foil or a plastic or composite be considered a change in novelty. Membranes which have adhesives applied which may either bond to oral tissues or alternatively to barrier materials should not be considered a change in novelty. The methods of application of the field isolation rubber dams are illustrative only of the basic principles of refining and perfecting a barrier seal with a field isolation rubber dam.

Although illustrations of the dams show the application of barrier materials, the dams may also be used without applied barrier materials. Merely listing the steps of a method in a certain manner or leaving out a step specified in a method of use does not constitute any limitation of on the order of the steps of any method described or a change in novelty. The foregoing description and drawings merely explain and illustrate the principles of the invention, but the invention is not limited thereto, except in so far as the claims are so limited. Those skilled in the art of dentistry will recognize obvious potential modifications and variations therein which are within the spirit and scope of the invention, but not a change in novelty.

I claim:

1. A rubber dam, comprising a sheet of elastomeric membrane with a slit-like central opening prepared in the elastic membrane to isolate portions of the dental alveolar arch.

2. A rubber dam as defined in claim 1, wherein a fabric or mesh is attached to the membrane around the central opening to to assist in creating a bond between a barrier material and the dam.

3. A rubber dam as defined in claim 1, wherein an adhesive is integrally applied to the membrane around the central opening of the dam

4. A rubber dam as defined in claim 3, wherein the adhesive is applied on an operative surface of the dam to assist in creating a bond between a manually applied barrier materials and the rubber dam membrane.

5. A rubber dam as defined in claim 3, wherein the adhesive is applied to a tissue surface of the dam to assist in creating a bond between the rubber dam and the dental alveolar tissues.

6. A rubber dam as defined in claim 3, wherein the adhesive is selected from the group consisting of an adhesive which lacks water solubility and an adhesive of limited water solubility.

7. A rubber dam as defined in claim 3, wherein the adhesive is selected from the group consisting of pressure-sensitive adhesive, a chemically activated adhesive, and a photoactivated adhesive.

8. A rubber dam for use in isolating the field of a dental procedure, comprising:
(a) a sheet of elastomeric material;
(b) an opening in the elastomeric material through which the dental structures of the alveolar arch are brought through the opening so that dental procedures may be performed; and
(c) structure around the opening in the elastomeric material for the attachment of a manually applied barrier material.

9. A rubber dam as defined in claim 8, wherein an integrally attached frame is attached around the periphery of the elastomeric membrane

10. A rubber dam for use in isolating the field of a dental procedure, comprising:
(a) a sheet of elastomeric material;
(b) an opening in the elastomeric material through which the dental structures of the alveolar arch are brought through the opening so that dental treatment may be performed; and
(c) structure around the opening in the elastomeric material for the attachment of the rubber dam directly to the patient's dental tissues.

11. A rubber dam as defined in claim 10, wherein an integrally attached frame is attached around the periphery of the elastomeric membrane

12. A rubber dam for use in isolating the field of a dental procedure, comprising:
(a) a sheet of elastomeric material;
(b) a slit-like opening in the elastomeric material through which the dental structures of the alveolar arch such as the teeth and soft tissues are brought through the opening for dental treatment; and
(c) a flange around the slit-like opening to which a barrier material with an integrally applied adhesive adheres to the dam.

13. A rubber dam as defined in claim 12, wherein an integrally applied frame is attached to the outer periphery of the rubber dam membrane.

14. A method of isolating tissues in the field of a dental procedure using a rubber dam of claim 1 and further comprising a barrier material attached to the rubber dam around the perimeter of the slit, comprising the step of using the barrier material to seal the interface of the dam and the tissues being isolated.

15. A method in which a series of teeth and their associated soft tissues are isolated in order to perform dental treatment, comprising the steps of:
(a) inserting a field isolation rubber dam with a fabric mesh material around a central opening into the mouth over a segment of the dental alveolar arch and bringing a group of teeth and associated gingival tissues through a slit-like central opening in the dam;
(b) applying a specialized cervical retraction rubber dam clamp over the dam to retain the dam in the mouth and to retract the rubber dam around the operative site in a manner which exposes both the teeth and soft tissues;
(c) applying a barrier material over the mesh material around the periphery of the operative site in order to create a moisture barrier around the operative site; and
(d) allowing the applied barrier material to polymerize in contact with the mesh material, thereby creating a bond between the barrier material and the rubber dam around the operative site.

16. A method in which a series of teeth and their associated soft tissues are isolated in order to perform dental treatment, comprising the steps of:
(a) selecting a field isolation rubber dam with an integrally applied adhesive on the operative side of the dam around a prepared central opening;
(b) removing a release liner covering the adhesive;
(c) inserting the field isolation rubber dam into the mouth over a segment of the dental alveolar arch and bringing a series of teeth and associated soft tissues through the slit-like central opening of the dam;
(d) applying a specialized cervical retraction rubber dam clamp over the dam to retain the dam in the mouth and to retract the rubber dam around the operative site in a manner which exposes both the teeth and soft tissues;
(e) applying a barrier material over the adhesive around the perimeter of the operative site to create a moisture seal around the operative site; and
(f) allowing the applied barrier material to polymerize in contact with the adhesive which bonds the barrier material to the dam.

17. A method in which a series of teeth and their associated soft tissues are isolated in order to perform dental treatment, comprising the steps of:
(a) selecting a field isolation rubber dam with an integrally applied tissue adhesive on the tissue surface of the rubber dam around a prepared central opening and removing a release liner over the tissue adhesive;
(b) inserting the field isolation rubber dam into the mouth over a segment of the dental alveolar arch and bringing a series of teeth and their associated soft tissues through the central opening prepared in the dam;
(c) applying a specialized cervical retraction rubber dam clamp over the dam in order to retain the dam and retract the dam around the operative site in a manner in which both the teeth and soft tissues are exposed for dental treatment;
(d) applying a slight pressure around the periphery of the operative site where the pressure-sensitive adhesive is in contact with the dental alveolar tissues in order to adhere the dam directly to the hard and soft tissues and improve the moisture barrier of the operative site.

18. A rubber dam as defined in claim 1 in which the external peripheral borders of the rubber dam membrane do not have an integral frame, but rather are stretched over a frame which is a separate device.

19. A rubber dam as defined in claim 1, wherein the rubber dam membrane has an integral frame attached to the periphery.

20. A rubber dam as defined in claim 19, wherein the integral external frame is comprised of a material selected from the group consisting of elastic, malleable, resilient, and rigid.

21. A rubber dam as defined in claim 19, wherein the integral frame is located wholly outside of the mouth of a patient and retracts the lips and cheeks of a patient in a complete circumferential manner.

22. A rubber dam as defined in claim 19, wherein the integral frame is an intraoral frame which does not retracts the lips and cheeks of a patient in a complete circumferential manner.

23. A rubber dam as defined in claim 1, wherein the rubber dam membrane is comprised of semi-translucent to permit a photoinitiated barrier adhesive integrally applied to the tissue side of the dam to be light cured through the membrane.
